(19) United States
(12) Patent Application Publication
(10) Pub. No.: US 2015/0006239 A1
(43) Pub. Date: Jan. 1, 2015

(54) SYSTEM, METHOD, AND APPARATUS FOR FRAUD DETECTION

(71) Applicant: Florian Hoffman, Schwetzingen (DE)

(72) Inventor: Florian Hoffman, Schwetzingen (DE)

(73) Assignee: SAP AG, Walldorf (DE)

(21) Appl. No.: 13/930,199

(22) Filed: Jun. 28, 2013

(51) Int. Cl. G06Q 10/06

(52) U.S. Cl. CPC G06Q 10/0635
USPC 705/7.28

(57) ABSTRACT

Embodiments of the present invention may provide a fraud detection system which may be used by fraud investigators to prove/disprove fraud. The system may scan business documents and generate a list of alerts associated with suspicious documents based on detection strategy business objects. The system may include a graphical user interface which may enable fraud investigators to analyze the alerts and determine whether suspicious business documents are related to fraudulent activity. The graphical user interface may display fraud pattern and investigation recipe business objects to enable fraud investigators to efficiently and accurately investigate potentially fraudulent activity.

### BACKGROUND

Experts estimate that, every year, approximately $3.5 trillion worth of fraud occurs worldwide. Industries that are especially vulnerable to fraudulent activity, such as the banking and insurance industries, need tools to detect, investigate, analyze, and prevent fraud as accurately and efficiently as possible. However, companies in the relevant industries are faced with the daunting task of analyzing millions of business documents to detect external and internal fraudulent activity. Current fraud analytics software is neither efficient nor accurate enough, as evidenced by the fact that a typical organization is at risk of losing up to five percent of its revenues to fraudulent activity. Moreover, as fraudulent activities evolve, existing fraud analytics software becomes obsolete.

### BRIEF DESCRIPTION OF THE DRAWINGS

FIG. 1 is a block diagram of a fraud management system according to an embodiment of the present application.

FIG. 2 illustrates a flow chart depicting an exemplary relationship between the business objects according to an embodiment of the present application.

FIG. 3 is a flow chart of a fraud detection method according to an embodiment of the present application.

FIG. 4(A) is a screenshot of a graphical user interface according to an embodiment of the present application.

FIG. 4(B) is a screenshot of a graphical user interface according to an embodiment of the present application.

FIG. 5(A) is a screenshot of a graphical user interface according to an embodiment of the present application.

FIG. 5(B) is a screenshot of a graphical user interface according to an embodiment of the present application.

FIG. 6(A) is a screenshot of a graphical user interface according to an embodiment of the present application.

FIG. 6(B) is a screenshot of a graphical user interface according to an embodiment of the present application.

FIG. 7(A) is a screenshot of a graphical user interface according to an embodiment of the present application.

FIG. 7(B) is a screenshot of a graphical user interface according to an embodiment of the present application.

FIG. 8 is a screenshot of a graphical user interface according to an embodiment of the present application.

FIG. 9 is a screenshot of a graphical user interface according to an embodiment of the present application.

FIG. 10 is a computer architecture capable of implementing fraud management software according to an embodiment of the present application

### DETAILED DESCRIPTION

Embodiments of the present invention may provide a fraud detection system which may be used by fraud investigators to prove/disprove fraud. The system may scan business documents and generate a list of alerts associated with suspicious documents based on detection strategy business objects. The system may include a graphical user interface which may enable fraud investigators to analyze the alerts and determine whether suspicious business documents are related to fraudulent activity. The graphical user interface may display fraud pattern and investigation recipe business objects to enable fraud investigators to efficiently and accurately investigate potentially fraudulent activity.

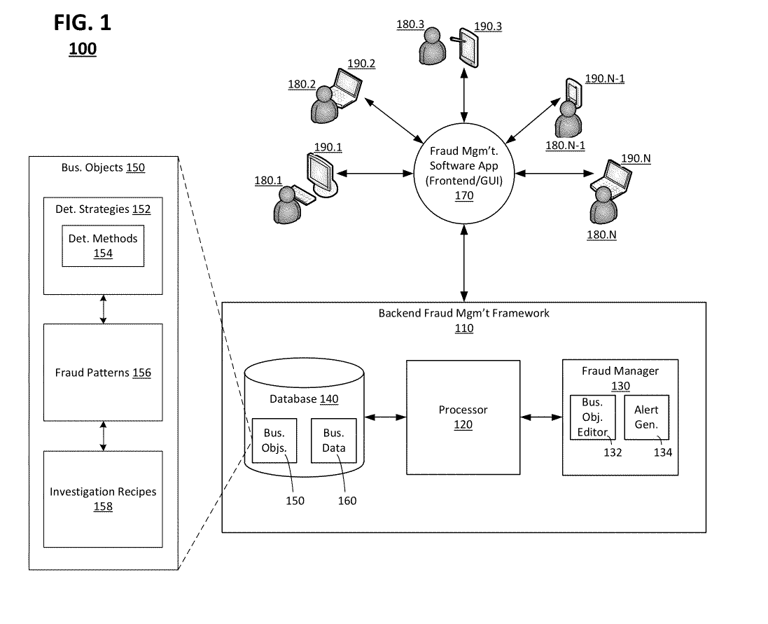

FIG. 1 illustrates a simplified block diagram of a fraud management system 100 according to embodiments of the present application. The system 100 may include a backend fraud management framework 110 and a frontend fraud management software application (or graphical user interface, “GUI”) 170. The backend fraud management framework 110 may include a combination of software and hardware used to generate the frontend software management software application 170. The fraud management software application 170 may be accessed by users 180.1-108.N to facilitate fraud detection and investigation within an enterprise setting. Although the fraud management system 100 may be implemented in various industries, such as the banking and finance industries, the present application will describe the system 100 as implemented in the insurance industry for exemplary purposes.

The plurality of fraud investigators (or users) 180.1-180.N may access the fraud management software application 170 using client devices 190.1-190.N to detect and analyze possible instances of fraudulent activity within a business enterprise. The devices 190.1-190.N may include, but are not limited to, desktop computers (190.1 for example), laptop computers (190.2 for example), tablets (190.3 for example), smart phones (190.N-1 for example), or any other devices that may be capable of accessing the fraud management software application 170 to allow fraud investigators 180.1-180.N to utilize the software application 170 provided by the backend fraud management framework 110.

The frontend fraud management software application 170 may be an enterprise application that may be accessed by the fraud investigators 180.1-180.N so they may conduct fraud investigations. The software application 170 may present data stored in the database 140 (described in further detail below), such as business documents, to the fraud investigators 180.1-180.N in an organized and efficient manner. Moreover, the software application 170 may provide analytics tools which may enable the investigators 180.1-180.N accurately and efficiently investigate possible instances of fraud within an enterprise setting (the fraud investigation process will be described in further detail below). The software application 170 may have several different configurations. For example, the application 170 may include a document viewer screen, several tool bars which may provide fraud analysis tools that may be used by the investigators 180.1-180.N, and several other screens/tabs associated with fraud patterns and investigation recipes (described in more detail below).

The backend fraud management framework 110 may include processor 120, a fraud manager 130, and a database 140. The processor 120 may execute instructions (e.g., instructions received from the fraud manager 130 or instructions received in response to user 180.1-180.N input) and manipulate/access data in the database 140. The processor may be provided in various configurations, such as a central processing unit (“CPU”), a field-programmable gate array (“FPGA”), an application specific integrated circuit (“ASIC”), or any other suitable logic device or combination of logic devices.

The database 140 may include any type of data storage adapted to searching and retrieval. The database 140 may include a SAP database (SAP DB), Informix, Oracle, DB2, Sybase, and other such database systems. The database 140 may include SAP's HANA (high performance analytic appliance) in-memory computing engine and other such in-memory databases. The database 140 may store business objects 150 and business data 160. The business data 160 may include business documents that may be analyzed by investigators 180.1-180.N to prove instances of fraudulent activity occurring within their respective business enterprise settings.

The business objects 150 may represent organized business data and associated tools that may be used by the investigators 180.1-180.N operating the software application 170 to detect and investigate fraud. The business objects 150 may be used to represent business operations, such as fraud operations. The types of business objects 150 may include detection strategies 152, fraud patterns 156, and investigation recipes 158. The business objects 150 may be accessed, utilized, and modified by the fraud manager 130 (described in further detail below) to facilitate the operation of the fraud management software application 170. The detection strategies 152 may include a set of detection methods 154, which represent a set of rules which may be used to flag specific business documents that satisfy these rules. The detection strategies may be used by the fraud manager 130 (described in further detail below) to scan and flag documents that may be related to fraudulent activity.

The fraud pattern business objects 156 may represent a recurring pattern of fraudulent behavior. Each of the detection strategy business objects 152 may be linked or associated with one or more fraud pattern business objects 156. Each fraud pattern business object 156 may include associated data, including a name to describe the fraud pattern and a modus operandi to describe the recurring fraudulent behavior. The investigation recipe business objects 158 may represent a possible way to prove a fraud pattern of a specific kind. Each investigation recipe business object 158 may include associated data, including a summary of the method of proving fraud and instructions, which may include a list of steps to execute the method of proving the fraud.

The fraud manager 130 may be a software program stored in memory (not shown), that may be executed by the processor 120 to accesses and modify the business objects 150 and the business data 160 in the database 140 in response to input from the fraud investigators 180.1-180.N using the fraud management software application 170. The fraud manager 130 may include a business object editor 132 and an alert generator 134. The business object editor 132 may allow the investigators 180.1-180.N to edit existing business objects 150 or create new business objects 150. For example, a senior fraud investigator may know of a specific type fraud (or fraud pattern) that occurs in the insurance industry and may further know different types of indicators (detection methods and detection strategies) that may be associated with that type of fraud. Moreover, the investigator may know a general set of instructions that may be used to prove the fraud at issue (investigation recipe). Therefore, the senior investigator may create a new instance of one or detection strategies 152, an associated fraud pattern 156, and an associated investigation recipe 158. Junior associates may subsequently be able to learn from and utilize the business objects 150 to detect fraud in a more efficient and accurate manner.

The alert generator 134 may utilize the detection methods 154 for each detection strategy business object 152 to scan the business documents 160 and generate alerts for business documents 160 that may possibly be related to fraudulent activity. The alert generator 134 may be programmed to run automatically at specific times or may be controlled by the fraud investigators 180.1-180.N. Once the alert generator 134 searches through and analyzes the business data 160, it may instruct the processor 120 to display a list of documents 160 and their associated alerts using the fraud management software application 170 for the investigators 180.1-180.N to analyze. Each flagged document may include associated text to indicate which detection strategy 152 was used to generate the alert and, if applicable, which fraud patterns 156 and investigation recipes 156 are associated with the triggered detection strategy 152. In this manner, when an investigator is analyzing a business document 160 that generated an alert by the alert generator 134, he/she may easily understand why the specific document 160 triggered the alert, which fraud pattern(s) 156 to be suspicious of, and how to prove the possible fraud pattern(s) 156 using an investigation recipe 158.

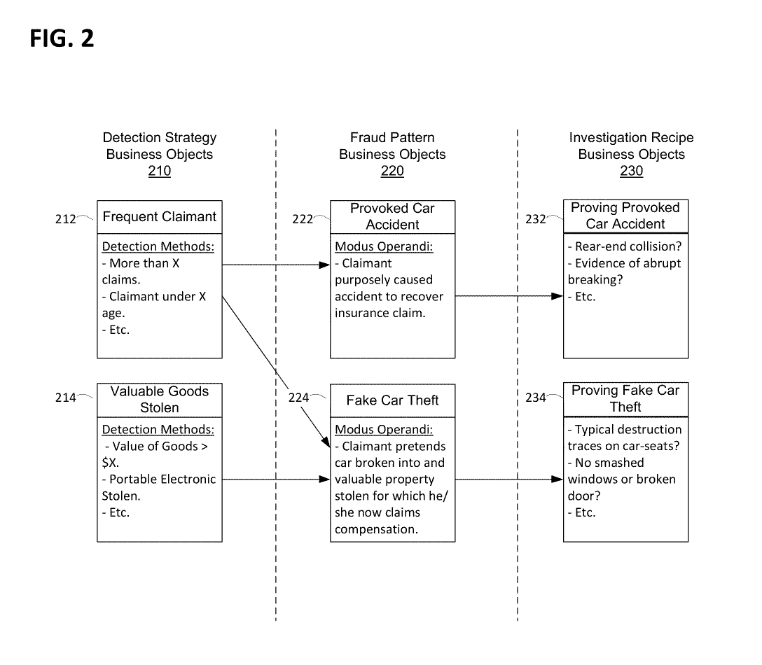

FIG. 2 illustrates a flow chart depicting an exemplary relationship between the business objects 150 described above with respect to FIG. 1. As described above, the system may have at least three types of business objects: (1) detection strategy business objects 210, (2) fraud pattern business objects 220, and (3) investigation recipe business objects 230. The business objects 210-220 may be related (or linked together) as shown by the arrows. FIG. 2 will now be described using examples of the types of business objects that may be used in the insurance industry.

In the insurance industry, the fraud management system may utilize several detection strategies such as a frequent claimant detection strategy 212 and a valuable goods stolen detection strategy 214 (and several other detection strategy business objects 210 not shown in FIG. 2 for purposes of brevity). Each detection strategy business object 210 may have set of detections methods (or rules) that may be utilized by the system to generate alerts for suspicious business documents. Continuing with the insurance example above, the frequent claimant business object 212 may include the following detection methods (or rules): the claimant has previously submitted more than a threshold amount (X) of claims, the claimant is under a certain age limit, etc. Moreover, the valuable good stolen detection strategy 214 may include the following detection methods: the value of the allegedly stolen goods is above a specific threshold amount, the stolen item is a portable electronic (such as a smart phone), etc. Thus, if the alert generator scans an insurance claim document where the item that was allegedly stolen is worth over $500, the system may generate an alert for the document. The alert may include the detection strategy(s) 210 and detection method(s) that generated the alert for the document along with any corresponding fraud patterns 220 or investigation recipes 230 that may possibly be associated with the document. For example, when the fraud investigator analyzes the document, he/she may see that the document was flagged because the item in question is worth over $500. Moreover, the investigator may be able to see and investigate potential fraud patterns associated with the document (rather than coming up with potential fraud patterns and investigation recipes on his/her own).

The frequent claimant detection strategy 212 and the valuable goods stolen detection strategy 214 may be associated with or linked to specific fraud pattern business object 210. For example, as shown in FIG. 2, the frequent claimant detection strategy 212 may be related to a provoked car accident fraud pattern 222 and a fake car theft fraud pattern 224 (the valuable goods stolen detection strategy 214 may also be related to the fake car theft fraud pattern 224). The association between the frequent claimant detection strategy 212 and the fraud patterns 222 and 224 may indicate that if an insurance claim is filed by a frequent claimant, there may be a possibility that the accident was a provoked car accident or a fake car theft. Each fraud pattern business object 220 may have associated data that may explain the underlying fraud pattern. For example, the provoked car accident fraud pattern business object 222 may include a “modus operandi” which may explain what a provoked car accident is. In this case, the “modus operandi” for a provoked car accident fraud pattern 222 may state the following: “Claimant purposely caused accident to recover insurance claim.” The fake care theft fraud pattern business object 224 may also have its own associated modus operandi. The modus operandi for each fraud pattern business objects 220 may be accessed by a fraud investigator by selecting a fraud pattern associated with a flagged business document.

Once an investigator selects a fraud pattern business object 220, the fraud management software application may also list an associated investigation recipe business object 230 (either on the same screen as the fraud pattern or on another related screen). The investigation recipe business objects 230 may provide general instructions that may help a fraud investigator prove (or confirm the absence of) a fraud pattern that may be associated with a flagged business document. Continuing with the insurance industry example above, the provoked car accident fraud pattern 222 may be linked or associated with an investigation recipe entitled, “Proving Provoked Car Accident” 232. The investigation recipe may include a set of instructions/methods for proving that the flagged business document may be related to provoked car accident. The instructions, for example, may include the following inquiries/instructions: “(1) Was the collision a rear-end collision?; (2) Was there any evidence of abrupt breaking?; (3) Look at the police report, etc.” Similarly, the fake care theft business object 224 may be linked or associated with a “Proving Fake Car Theft” investigation recipe business object 234.

By relating and/or linking together related detection strategy business objects 210, fraud pattern business objects 220, and investigation recipe business objects 230, a fraud investigator may quickly and effectively analyze fraud alerts generated by the fraud management system. The fraud management software may provide an up-to-date knowledge base which may be used to teach junior fraud investigators that may not be as familiar with fraud detection and investigation as senior fraud investigators.

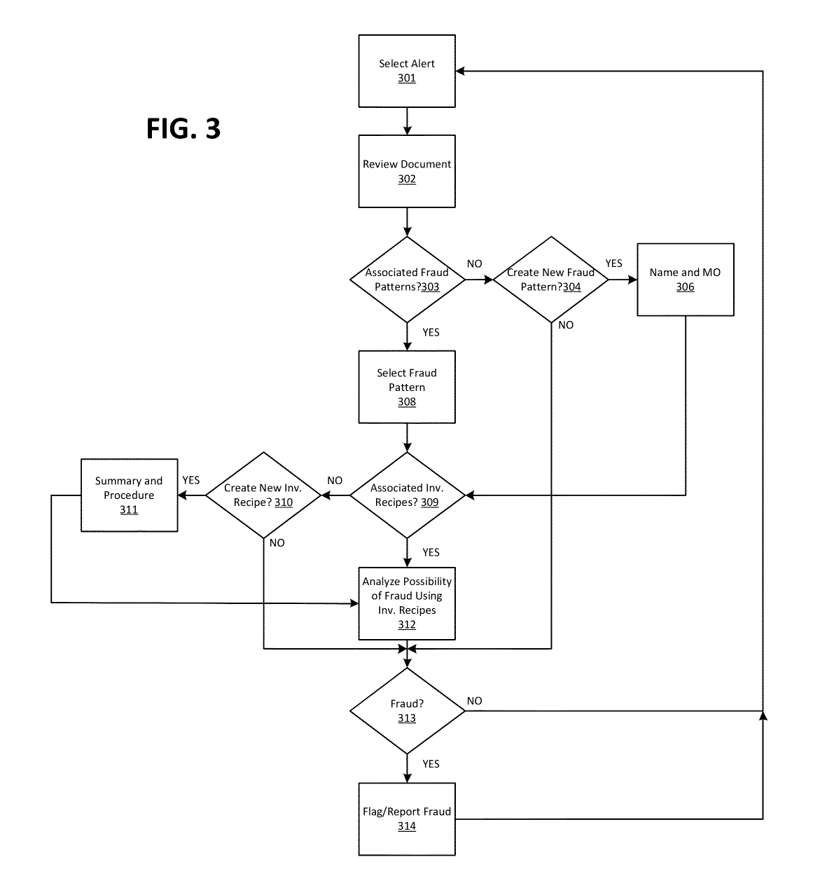

FIG. 3 is a flow chart illustrating a general operation of the fraud management system 100 according to embodiment of the present application. Initially, a fraud investigator may log-in to his/her computer and launch the fraud management software described above with respect to FIG. 1. Once the investigator logs in, he or she may view a list of alerts associated with documents that may be flagged by an alert generator (similar to the alert generator 134 of FIG. 1). At step 301, the fraud investigator may select an alert to investigate whether the business document that triggered the alert is associated with fraudulent activity. The investigator may subsequently review the document and the detection strategy that was used to generate the alert for the document (step 302).

After reviewing the document and the detection strategy, the investigator may determine whether the detection strategy has any fraud patterns associated with it (step 303). If the alert is not associated with any fraud patterns, the fraud investigator may decide whether or not to create a new fraud pattern that may be associated with the alert (step 304). If the investigator decides not to create a new fraud pattern (i.e., if the investigator is not experienced enough to do so), her/she may jump to step 313 and determine whether the document is related to fraudulent activity based on his/her own knowledge or instincts. If the investigator decides to create a new fraud pattern (step 306), he or she may do so by, for example, clicking a “New Fraud Pattern” button on a toolbar in the fraud management software application. A “New Fraud Pattern” dialog box may be displayed and may include a “Name” field and a “Modus Operandi” field. The investigator may enter in appropriate information in each field and click a “Save” button to create the new fraud pattern. Once the new fraud pattern is created, the investigator may associate the fraud pattern to the detection strategy that generated the alert the investigator is analyzing. Additionally, the investigator may associate the fraud pattern with other detection strategies (e.g., by using a mouse to draw a line between the fraud pattern and the associated detection strategies) that may be unrelated to the present alert. The investigator may then jump to step 309 (discussed below).

If the alert is associated with a fraud pattern, the investigator may select the fraud pattern (step 308) and may read the modus operandi associated with the fraud pattern. Next, the investigator may determine whether the fraud pattern is associated with an investigation recipe (step 309). If there is not an associated investigation recipe, the investigator may have the option to create a new investigation recipe for the selected fraud pattern. If the investigator does not have the knowledge to create a new investigation recipe for the selected fraud pattern, he may jump to step 313 (described in further detail below). If the investigator would like to create a new investigation recipe for the selected fraud pattern, he or she may do so by, for example, clicking a “New Investigation Recipe” button on a toolbar in the fraud management software application. A “New Investigation Recipe” dialog box may be displayed and may include a “Summary” field and a “Procedure” field. The investigator may enter in appropriate information in each field and click the “Save” button to create the new investigation recipe. The investigator may then jump to step 312.

If the alert is associated with a fraud pattern, the investigator may analyze the possibility of fraud associated with the document at issue by following the “Procedures” listed in the investigation recipe business object. After following the “Procedures,” the investigator may make a determination as to whether the questionable document is associated with the fraud pattern at issue. If the investigator determines that the document is not related to fraud, he or she may select the next alert in the alert list (back to step 301) and repeat the above process again until he/she finishes analyzing all of the alerts. If the investigator determines that the document is related to fraud, he/she may flag the document and/or report the instance of fraud associated with the document at issue (step 314). The investigator may then return to step 301 and analyze the remaining alerts in the alert list generated by the fraud management software.

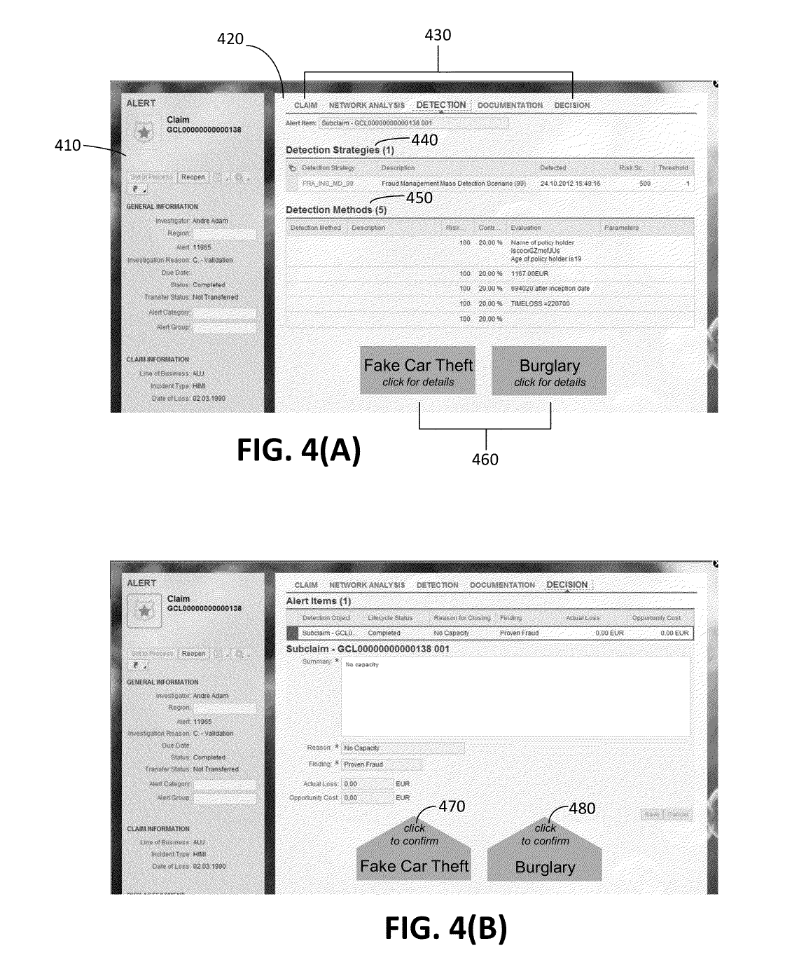

FIGS. 4-9 are screenshots of the various aspects of an exemplary fraud management software application that fraud investigators may utilize to investigate business documents that may be connected with fraudulent activity. The screenshots are merely exemplary of a software application an investigator may use to investigate instances of fraud within an enterprise setting. The techniques and principles of the present application may be implemented in various software configurations (i.e., different types of software applications) that are suitable for fraud detection in various industries that may be affected by fraudulent activity.

FIG. 4(A) is a screenshot of a potential user interface for a fraud management software application for use in the insurance industry according to an embodiment of the present application. A left side 410 of the user interface window may include general information regarding the insurance claim, such as the claim number, the investigator assigned to the claim, the claim's status, etc. A right side 420 of the user interface window may include specific information regarding the claim document at issue and analysis tools which may enable the investigator to determine whether the claim is fraudulent. For example, the right side 420 of the user interface window may include a plurality of different tabs 430, such as a “Claim” tab, a “Network Analysis” tab, a “Detection” tab, a “Documentation” tab, and a “Decision” tab. When each tab is selected by the fraud investigator, different options and information are displayed on the right side 420 of the window. In FIG. 4(A), the “Detection” tab is the selected tab. The “Detection” tab may list the detection strategies 440 and detection methods 450 that were used to generate the alert for the claim document. Moreover, the “Detection” tab may display potential fraud patterns 460 (e.g., Fake Car Theft or Burglary fraud patterns) that the investigator may want to consider investigating for the claim document at issue.

Continuing with the example discussed above with respect to FIG. 4(A), FIG. 4(B) is a screenshot of the “Decision” tab. The investigator may use this tab to confirm a suspected fraud pattern that may be associated with the insurance claim document that generated the alert. For example, the fraud investigator may “Click to Confirm” either a “Fake Car Theft” 470 or “Burglary” 480 fraud pattern. Once the investigator confirms either fraud pattern, he/she may move on to the next alert in his/her alert queue.

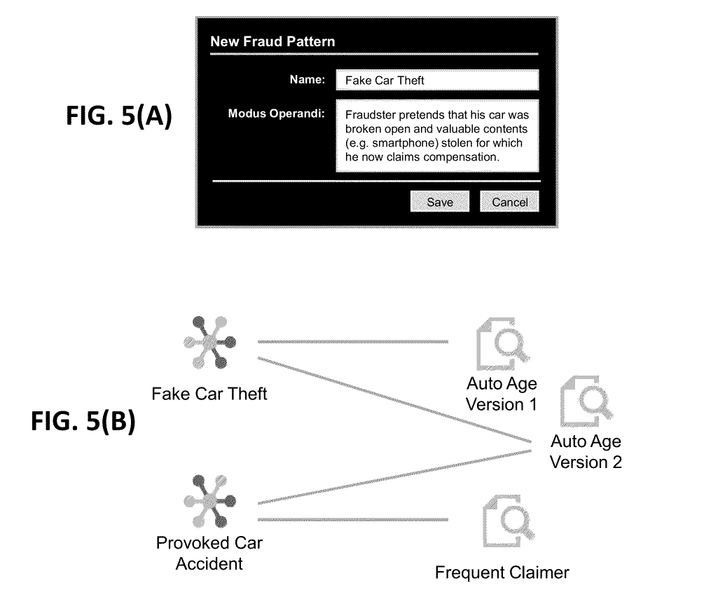

FIG. 5(A) is a screenshot of a “New Fraud Pattern” window which may be displayed when a fraud investigator clicks on a button to create a new fraud pattern when he/she is analyzing a flagged business document. In FIG. 5(A), the creation of a “Fake Car Theft” fraud pattern business object is shown. The window may include two (or more) fields such as a “Name” field and a “Modus Operandi” field. The investigator may enter the appropriate info in each field and save the new fraud pattern. For example, the fraud investigator may enter “Fake Car Theft” into the “Name” field. Moreover, the investigator may enter “Fraudster pretends that his car was broken open and valuable contents (e.g., smartphone, radio) stolen for which he know claims compensation,” in the “Modus Operandi” field. According to other embodiments of the present application, a new fraud pattern business object may also be created either before or after a fraud investigator is analyzing alerts. In such cases, the investigator (normally, a senior investigator) may want to create fraud patterns ahead of time based on his or her knowledge to ensure that other less experienced investigators see the fraud patterns during their fraud investigations.

FIG. 5(B) is a screenshot of a window within a fraud management software application which may allow a fraud investigator to associate detection strategy business objects with fraud pattern business objects. For example, when a fraud investigator is analyzing a business document that generated a fraud alert, the fraud management software application may display the detection method that was utilized to generate the alert. The fraud investigator may then click on a button or link which may allow him/her to associate the detection strategies with relevant fraud patterns. On the left side of the “Association” window shown in FIG. 5(B), there may be a list of detection strategies that were utilized to generate an alert for the document at issue. On the right hand side of the “Association” window, there may be a list of fraud patterns. The investigator may use a mouse to draw a line between the detection strategies and fraud patterns that may be associated with the detection strategies. For example, as shown in FIG. 5(B), a “Frequent Claimer” detection strategy may be linked to a “Provoked Car Accident” fraud pattern. According to other embodiments of the present application, links between detection strategies and fraud patterns may be created either before or after a fraud investigator is analyzing alerts. In such cases, the investigator (normally, a senior investigator) may want to establish the associations ahead of time based on his or her knowledge to ensure that other less experienced investigators see the related fraud patterns during their fraud investigations.

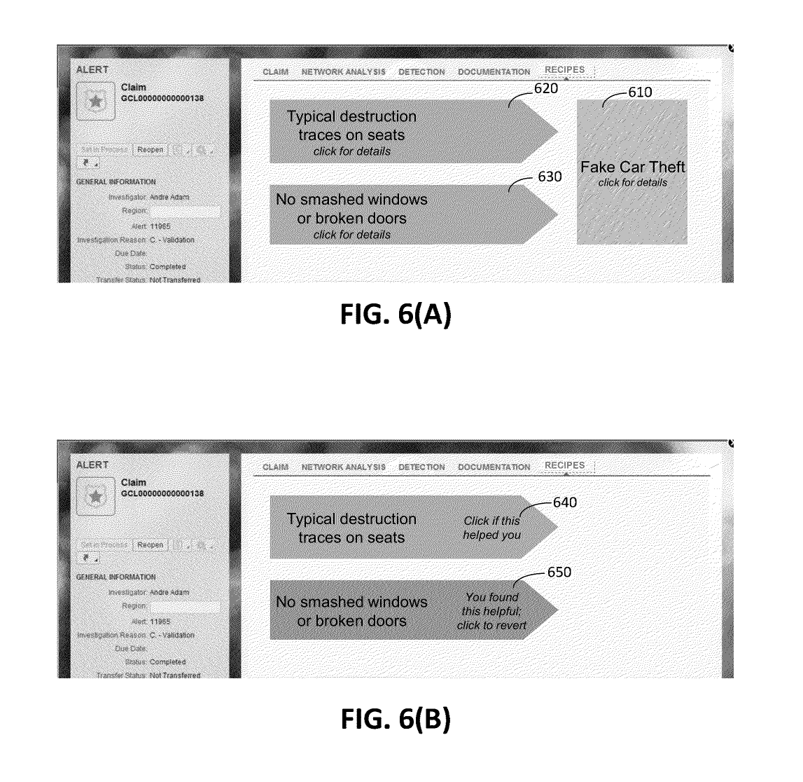

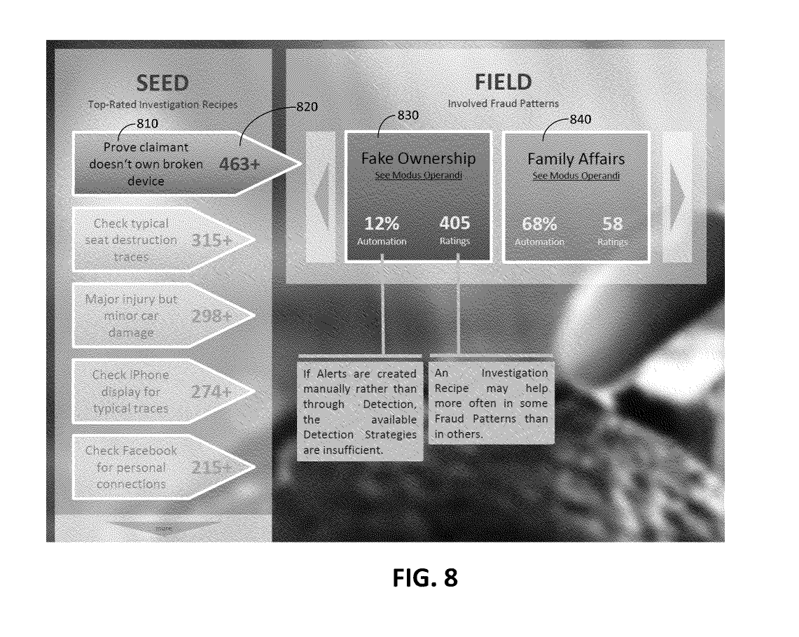

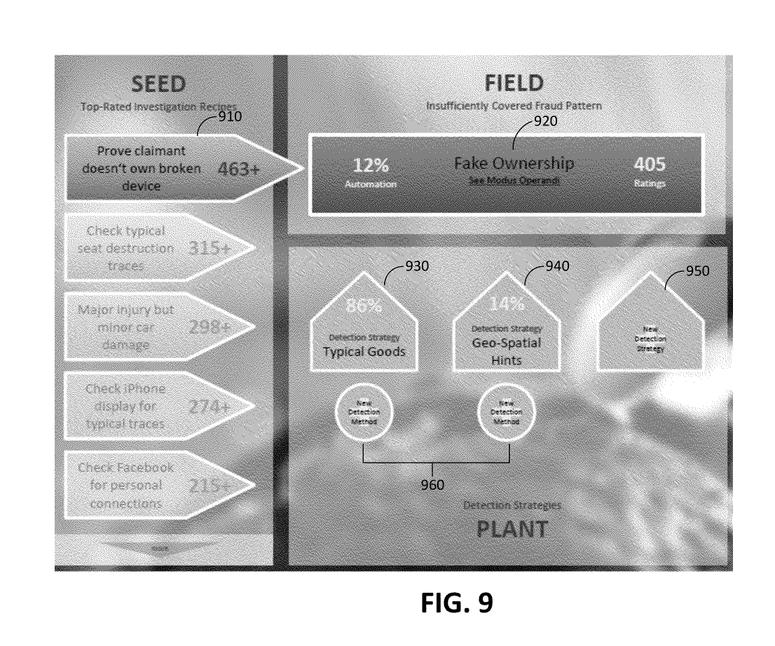

FIG. 6(A) is a screenshot of a potential user interface for a “Recipe” tab in a fraud management software application according to an embodiment of the present invention. The “Recipe” tab may be navigated to by a user clicking on the tab or by a user clicking on a “Click for Details” button associated with a fraud pattern (similar to the “Click for Details” button in FIG. 4(A)). The “Recipe” tab may display a fraud pattern button, such as a “Fake Car Theft” fraud pattern 610, that the investigator may be trying to prove. Once the investigator clicks the fraud pattern button 610, the “Recipe” tab may display procedure/instruction buttons that may be accessed by the investigator to prove the fraud pattern. Continuing with the “Fake Car Theft” fraud pattern 610 example in FIG. 6(A), the investigator may click on the “Typical Destruction Traces on Seats” or “No Smashed Windows or Broken Doors” buttons which may be the procedures/instructions of the investigation recipe which may be used to prove a fake car theft. Once the investigator clicks on the procedures/instructions, he or she may receive more detailed explanation regarding the instructions and how they may be related to proving the fraud pattern at issue. Additionally, as shown in FIG. 6(B), an investigator may be able to provide feedback regarding the procedures/instructions 640 and 650 of an investigation recipe, such as clicking a button if the procedures 640 and 650 were helpful in proving a specific fraud pattern. This may allow the fraud management software to rank the best investigation recipe procedures (described in further detail below with respect to FIGS. 8-9).

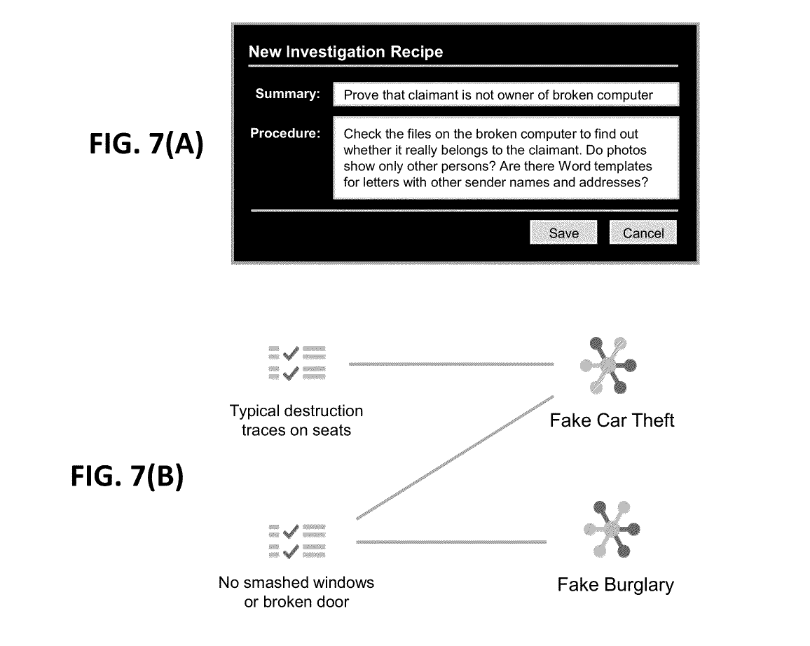

FIG. 7(A) is a screenshot of a “New Investigation Recipe” window which may be displayed when a fraud investigator clicks on a button to create a new investigation recipe business object when he/she is analyzing fraud patterns associated with flagged business documents. In FIG. 7(A), the creation of the “Proving That Claimant Is Not Owner of Broken Computer” investigation recipe is shown. The window may include two (or more) field such as a “Summary” field and a “Procedure” field. The investigator may enter the appropriate information in each field and save the new investigation recipe. For example, the fraud investigator may enter “Prove That Claimant is Not Owner of Broken Computer” in the “Summary” field. Moreover, the investigator may enter “Check the files on the broken computer to find out whether it really belongs to claimant. Do photos show only other persons? Are there Word templates for letters with other sender names and addresses?” in the “Procedure” field. According to other embodiments of the present application, a new investigation recipe business object may also be created either before or after a fraud investigator is analyzing alerts. In such cases, the investigator (normally, a senior investigator) may want to create investigation recipes ahead of time based on his or her knowledge to ensure that other less experienced investigators see the investigation recipes during their fraud investigations.

FIG. 7(B) is a screenshot of a window within a fraud management software application which may allow a fraud investigator to associate fraud pattern business objects with investigation recipe business objects. For example, when a fraud investigator is analyzing a business document that generated a fraud alert, the fraud management software application may display the fraud pattern associated with the detection method that was utilized to generate the alert. The fraud investigator may then click on a button or link which may allow him/her to associate one or more investigation recipes with relevant fraud patterns. On the left side of the “Association” window shown in FIG. 7(B), there may be a list of fraud patterns that may be related to the flagged document. On the right hand side of the “Association” window, there may be a list of investigation recipes. The investigator may use a mouse to draw a line between the fraud patterns and investigation recipes that may be associated with the fraud patterns. For example, as shown in FIG. 7(B), a “Fake Car Theft” fraud pattern may be linked to “Typical Destruction Traces on Seats” and “No Smashed Windows or Broken Door” investigation recipe procedures. According to other embodiments of the present application, links between investigation recipes and fraud patterns may be created either before or after a fraud investigator is analyzing alerts. In such cases, the investigator (normally, a senior investigator) may want to establish the associations ahead of time based on his or her knowledge to ensure that other less experienced investigators see the relevant investigation recipes during their fraud investigations.

FIG. 8 is a screenshot of a user interface within a fraud management software application which may allow fraud investigators and system administrators to determine which investigation recipes are the “Top-Rated” in the system. As described above with respect to FIG. 6(B), fraud investigators may be able to rate investigation recipes. By rating an investigation recipe, an investigator may state that the investigation recipe helped him/her in drawing a conclusion that the flagged business document is associated with fraud or not. As shown in FIG. 8, a counter 820 may keep track of the number of times an investigation recipe was ranked as helpful by a fraud investigator. Moreover, once a ranked investigation recipe is clicked on, the software may display the fraud patterns 830 and 840 associated with that investigation recipe. The software may also display a number of times that investigation recipe was rated as helpful for proving each of the displayed fraud patterns. In this case, the “Prove Claimant Doesn't Own Broken Device” investigation recipe 830 may have been helpful in proving (or disproving) the “Fake Ownership” fraud pattern 810 in a specific enterprise setting because it was ranked as helpful 405 times when used to prove fake ownership.

FIG. 9 illustrates a screenshot of a user interface within a fraud management software application which may allow fraud investigators to use top rated investigation recipes to create new detection strategies (otherwise referred to as “Rule Breeding”). Once an investigation recipe reaches a certain “maturity” through repeated (positive) ratings, the fraud investigators building the detection strategies may be made aware of them. This may happen automatically, for example by sending them an email whenever an investigation recipe exceeds an “X-number of ratings as useful” threshold. Once the fraud investigators receive such a notification, he/she may research the investigation recipe to try to translate it into detection methods that can be added to detection strategies. For example, in FIG. 9, the “Prove Claimant Doesn't Own Broken Device” investigation recipe may be highly rated. Once the fraud investigator clicks on the investigation recipe, associated fraud patterns, such as a fake ownership fraud pattern 920 may be displayed. Once the fraud pattern is clicked, the associated detection strategies, such as a “Typical Goods” detection strategy 930 or a “Geo-Spatial Hints” detection strategy 940, may be displayed. The detection strategies 930 and 940 may indicate how often they are related to successfully proving the fraud pattern they are associated with (e.g., by displaying a percentage value). Once a fraud investigator sees the relationships between the investigation recipes, the fraud patterns, and the detection methods, he/she may create new detection strategies/methods which may make it easier/more effective to prove a specific investigation recipe in the future (i.e., by clicking the “New Detection Strategy” button 950 or the “New Detection Method” buttons 960).

According to an embodiment of the present application, if an investigation recipe has been completely translated into detection methods, it may be categorized, for example, as “deprecated.” This may indicate that the investigation recipe no longer needs to be manually proven/executed because this now happens automatically. Categorizing may be preferable over deleting the investigation recipe, because this would preserve the textual explanation. The investigation recipe may also be associated with the detection methods it has been translated into, to make the origin of the detection methods clear and provide background information for future improvement.

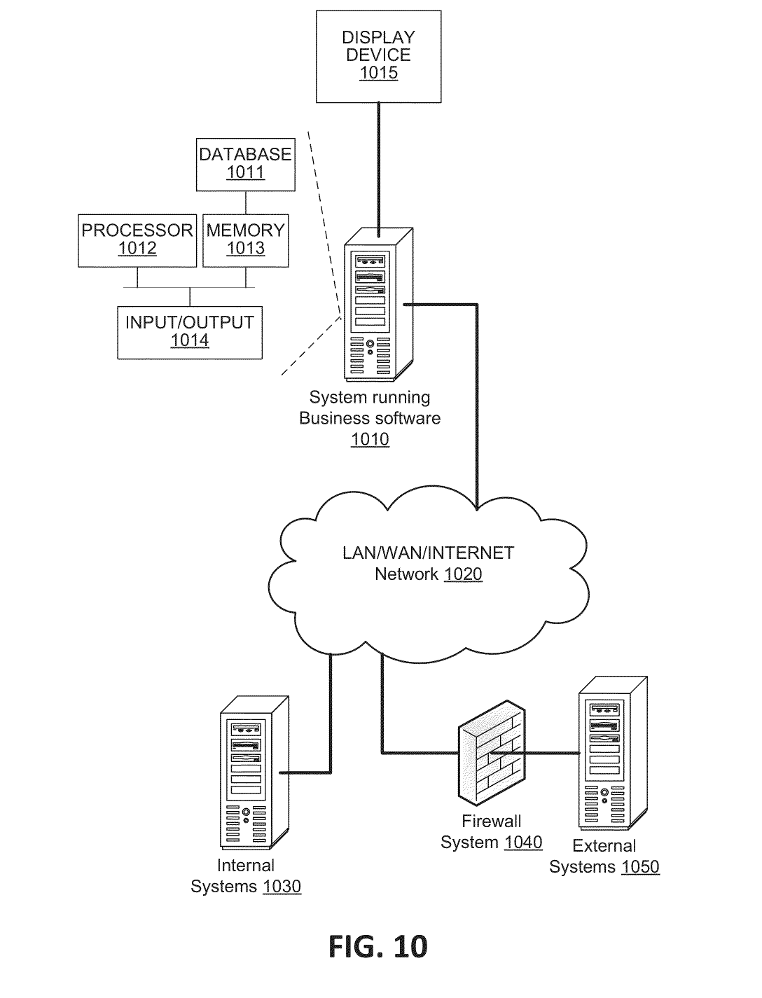

FIG. 10 is an exemplary computer architecture according to an embodiment of the present application. The system 1010 running the fraud management software may be coupled to a display device 1015, existing internal systems 1030 through a network 1020 and to external systems 1050 through the network 1020 and firewall system 1040. The system running fraud management software 1010 may include a desktop computer, laptop computer, tablet PC, client computer, mobile phone, central computer in a vehicle, any device with a touch screen, and any other computer. The display device 1015 may include a computer monitor, a touch screen, a tablet PC screen, a mobile phone screen, and any other displays. The existing internal systems 1030 may include a server and may provide business data and/or other data. The external systems 1050 may include a server and may be maintained by a third party, such as an information service provider, and may contain business data and/or other data, that may be updated by the third party on a periodic basis. The system running fraud management software 1010 may interact with these external systems to obtain updates through a firewall system 1040 separating the internal systems from the external systems.

A person having ordinary skill in the art will appreciate that while internal systems 1030 and external systems 1050 are included in FIG. 10, in some embodiments, one or both of these systems may not be required. In an embodiment, the functionality provided by the internal systems 1030 and external systems 1050 may be provided by the system running the fraud management software 1010.

Each of the systems in FIG. 10 may contain a processing device 1012, memory 1013, a database 1011, and an input/output interface 1014, all of which may be interconnected via a system bus. In various embodiments, each of the systems 1010, 1030, 1040, and 1050 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 1013 may contain different components for retrieving, presenting, changing, and saving data. Memory 1013 may include a variety of memory devices, for example, Dynamic Random Access Memory (DRAM), Static RAM (SRAM), flash memory, cache memory, and other memory devices. Additionally, for example, memory 1013 and processing device(s) 1012 may be distributed across several different computers that collectively comprise a system.

Database 1011 may include any type of data storage adapted to searching and retrieval.

The database 1011 may include SAP database (SAP DB), Informix, Oracle, DB2, Sybase, and other such database systems. The database 10′11 may include SAP's HANA (high performance analytic appliance) in-memory computing engine and other such in-memory databases.

Processing device 1012 may perform computation and control functions of a system and comprises a suitable central processing unit (CPU). Processing device 1012 may comprise a single integrated circuit, such as a microprocessing device, or may comprise any suitable number of integrated circuit devices and/or circuit boards working in cooperation to accomplish the functions of a processing device. Processing device 1012 may execute computer programs, such as object-oriented computer programs, within memory 1013.

Although the foregoing techniques have been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. Those skilled in the art will appreciate that these techniques may be implemented in other ways without departing from the spirit and substantive features of the invention. The present embodiments are therefore to be considered in all respects as illustrative and not restrictive.

We claim:

1. A fraud detection system comprising:
a database comprising business objects and business documents, wherein the business objects comprise detection strategy, fraud pattern, and investigation recipe business object types;
a processor to access and modify data stored in the database;
a fraud manager program executed by said processor to execute the detection strategy business objects to scan the business documents and generate a list of alerts corresponding to suspicious business documents; and
a display device to display the list of alerts and for each alert, a detection strategy business object used to create the alert and a fraud pattern business object related to the detection strategy.

2. The fraud detection system of claim 1, wherein the display device also displays, for each alert, an investigation recipe business object related to the fraud pattern business object.

3. The fraud detection system of claim 1, wherein each detection strategy business object comprises a set of detection methods.

4. The fraud detection system of claim 1, wherein related detection strategy, fraud pattern, and investigation recipe business objects are linked together.

5. The fraud detection system of claim 1, further comprising a graphical user interface configured to allow a user to view an alert corresponding to a suspicious business document, view the suspicious business document, view a detection strategy business object used to generate the alert, view a corresponding fraud pattern business object related to the detection strategy used to generate the alert, and view a corresponding investigation recipe object related to the fraud pattern business object.

6. The fraud detection system of claim 1, wherein a user may create new business objects.

7. The fraud detection system of claim 1, wherein a user may rank the business objects.

8. A method comprising:
scanning, using a processor, a plurality of business documents in a database using detection strategy business objects and generating a list of alerts associated with suspicious business documents;
displaying the list of alerts on a display device; and
for each alert, displaying a detection strategy business object used to create the alert and a fraud pattern business object related to the detection strategy.

9. The method of claim 8, wherein, for each alert, the displaying further comprises displaying an investigation recipe business object related to the fraud pattern business object.

10. The method of claim 8, wherein each detection strategy business object comprises a set of detection methods.

11. The method of claim 8, further comprising linking together related detection strategy, fraud pattern, and investigation recipe business objects.

12. The method of claim 8, further comprising providing a graphical user interface configured to allow a user to view an alert associated with a suspicious business document, view the suspicious business document, view a detection strategy business object used to generate the alert, view a corresponding fraud pattern business object related to the detection strategy used to generate the alert, and view a corresponding investigation recipe object related to the fraud pattern business object.

13. The method of claim 12, wherein the graphical user interface is further configured to allow a user to create new business objects.

14. The method of claim 12, wherein the graphical user interface is further configured to allow a user to rank the business objects.

15. A method comprising:
storing, on a database, a plurality of detection strategy business objects used to scan business documents and generate alerts corresponding to suspicious business documents;
storing, on the database, a plurality of fraud pattern business objects that define a potential instance of fraud associated with corresponding detection strategy business objects;
storing, on the database, a plurality of investigation recipe business objects that provide instructions associated with proving corresponding instances of fraud associated with corresponding fraud pattern business objects;
displaying, using a display device, a list of alerts generated using the detection strategy business objects, and
for each alert, displaying a fraud pattern business object related to a detection strategy used to generate the alert.

16. The method of claim 15, wherein, for each alert, the displaying further comprises displaying an investigation recipe business object related to the fraud pattern business object.

17. The method of claim 15, wherein each detection strategy business object comprises a set of detection methods.

18. The method of claim 15, further comprising linking together related detection strategy, fraud pattern, and investigation recipe business objects.

19. The method of claim 15, further comprising providing a graphical user interface configured to allow a user to view an alert associated with a suspicious business document, view the suspicious business document, view a detection strategy business object used to generate the alert, view a corresponding fraud pattern business object related to the detection strategy used to generate the alert, and view a corresponding investigation recipe object related to the fraud pattern business object.

20. The method of claim 19, wherein the graphical user interface is further configured to allow a user to create new business objects.

21. The method of claim 19, wherein the graphical user interface is further configured to allow a user to rank the business objects.

22. The method of claim 21, wherein new detection strategies are created based on ranked investigation recipes.

23. A fraud detection system comprising:
a database comprising business objects and business documents, wherein the business objects comprise detection strategy, fraud pattern, and investigation recipe business object types, wherein:
each detection strategy business object comprises detection methods which represent a set of rules used to analyze and flag suspicious business documents that meet any one of the rules;
each fraud pattern business object comprises a modus operandi and a link to one or more detection strategy business objects which may be associated with the fraud pattern business object; and
each investigation recipe business object is linked to at least one fraud pattern business object and comprises a set of procedures used to prove an instance of fraud associated with the at least one fraud pattern business object;
a processor to access and modify data stored in the database;
a fraud manager program executed by said processor to execute the detection methods of each detection strategy business object to scan the business documents and generate a list of alerts corresponding to suspicious business documents; and
a display device to display a graphical user interface comprising a list of alerts and for each alert, a detection strategy business object used to create the alert, a fraud pattern business object related to the detection strategy business object, and an investigation recipe business object related to the fraud pattern business object.
